(19) United States
(12) Patent Application Publication
(10) Pub. No.: US 2018/0249243 A1
(43) Pub. Date: Aug. 30, 2018

(54) SPEAKER DEVICE

(71) Applicant: Panasonic Intellectual Property Management Co., Ltd., Osaka (JP)

(72) Inventors: KAZUKI HONDA, Osaka (JP); TAKAFUMI YUASA, Osaka (JP); AKIHISA KAWAMURA, Osaka (JP); TOSHIYUKI MATSUMURA, Osaka (JP); SHUJI SAIKI, Nara (JP); SATOSHI TAKAYAMA, Mie (JP); SUEMEI FUKUHARA, Osaka (JP); ISAO KURAMITSU, Osaka (JP); IPPEI KIYAMA, Hyogo (JP)

(21) Appl. No.: 15/753,259

(22) PCT Filed: Aug. 8, 2016
(86) PCT No.: PCT/JP2016/003643

§ 371 Date: Feb. 17, 2018

(30) Foreign Application Priority Data
Sep. 1, 2015 (JP) 2015-172384
Mar. 10, 2016 (JP) 2016-047610

(51) Int. Cl. H04R 1/30; H04R 1/40

(52) U.S. Cl. CPC H04R 1/30; H04R 1/403

(57) ABSTRACT

A loudspeaker device includes: a plurality of loudspeaker units; and a plurality of horns provided in the plurality of loudspeaker units, respectively, the plurality of horns each restricting spread of sound output from a corresponding one of the loudspeaker units to a predetermined range.

### TECHNICAL FIELD

The present disclosure relates to a loudspeaker device.

### BACKGROUND ART

Patent Literature (PTL) 1 discloses a bass reflex type loudspeaker device. The loudspeaker device disclosed in PTL 1 includes an enclosure, a loudspeaker unit, and a duct. The loudspeaker unit is disposed in and mounted on the enclosure. The duct is disposed in the enclosure to communicate between the inside and outside of the enclosure for ventilation. In the loudspeaker device, air in the duct resonates in the case that the loudspeaker unit vibrates at a predetermined low frequency. Therefore, in the loudspeaker device, sound output increases at the low frequency.

### CITATION LIST

### Patent Literature

PTL 1: Unexamined Japanese Patent Publication No. 2014-049999

### SUMMARY

The present disclosure provides a loudspeaker device that can improve sound quality.

A loudspeaker device according to the present disclosure includes: a plurality of loudspeaker units; and a plurality of horns provided in the plurality of loudspeaker units, respectively, the plurality of horns each restricting spread of sound output from a corresponding one of the loudspeaker units to a predetermined range.

The sound quality can be improved in the loudspeaker device of the present disclosure.

### BRIEF DESCRIPTION OF DRAWINGS

FIG. 1 schematically illustrates a configuration example of an acoustic system including a loudspeaker device according to a first exemplary embodiment.

FIG. 2 is a perspective view schematically illustrating a configuration example of the loudspeaker device of the first exemplary embodiment.

FIG. 3 is a perspective view schematically illustrating a configuration example of the loudspeaker device of the first exemplary embodiment.

FIG. 4 is a perspective view schematically illustrating a configuration example of the loudspeaker device of the first exemplary embodiment.

FIG. 5 is a perspective view schematically illustrating an example of an internal structure of the loudspeaker device of the first exemplary embodiment.

FIG. 6 is a perspective view schematically illustrating an example of the internal structure of the loudspeaker device of the first exemplary embodiment.

FIG. 7 is a perspective view schematically illustrating an example of the internal structure of the loudspeaker device of the first exemplary embodiment.

FIG. 8 is a side view schematically illustrating an example of the internal structure of the loudspeaker device of the first exemplary embodiment.

FIG. 9 is a perspective view schematically illustrating a configuration example of an acoustic tube in the loudspeaker device of the first exemplary embodiment.

FIG. 10 is a side view schematically illustrating a configuration example of a pedestal included in the loudspeaker device of the first exemplary embodiment and a periphery of the pedestal.

FIG. 11 is a perspective view schematically illustrating a configuration example of a tweeter included in the loudspeaker device of the first exemplary embodiment.

FIG. 12 is a top view schematically illustrating a configuration example of the tweeter included in the loudspeaker device of the first exemplary embodiment.

FIG. 13 schematically illustrates an example of a relationship between a sound pressure and a frequency of a woofer included in the loudspeaker device of the first exemplary embodiment.

FIG. 14 schematically illustrates an example of a relationship between an excursion and a frequency of a diaphragm of a woofer loudspeaker unit included in the loudspeaker device of the first exemplary embodiment.

FIG. 15 schematically illustrates an example of a relationship between impedance and a frequency of the woofer loudspeaker unit included in the loudspeaker device of the first exemplary embodiment.

FIG. 16 is a block diagram illustrating a configuration example of components associated with boost control of the woofer loudspeaker unit included in the loudspeaker device of the first exemplary embodiment.

### DESCRIPTION OF EMBODIMENTS

Hereinafter, exemplary embodiments will be described in detail with reference to the drawings as needed. However, the unnecessarily detailed description is occasionally omitted. For example, the detailed description of the already well-known item and the overlapping description of the substantially same configuration are occasionally omitted. This is because unnecessary redundancy of the following description is avoided for the purpose of easy understanding of those skilled in the art.

The accompanying drawings and the following description are provided in order that those skilled in the art sufficiently understand the present disclosure, but it is not intended that a subject matter of claims is limited to the accompanying drawings and the following description.

Each drawing is a schematic diagram, and is not necessarily precise depictions. In each drawing, the substantially same component is designated by the same reference mark, and the description is occasionally omitted or simplified.

### First Exemplary Embodiment

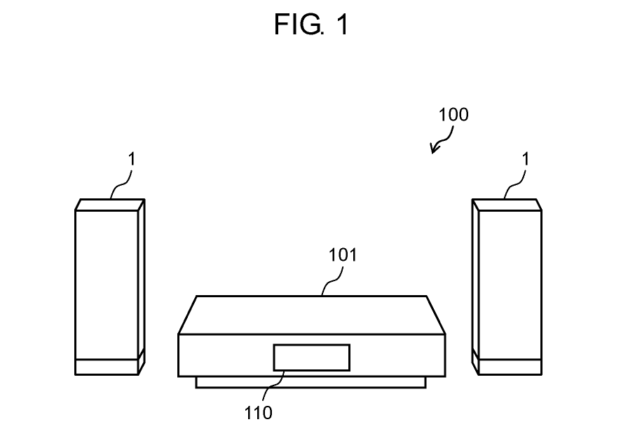

A loudspeaker device according to a first exemplary embodiment and an acoustic system including the loudspeaker device will be described below with reference to FIGS. 1 to 15.

### [1-1. Entire Configuration of Acoustic System]

FIG. 1 schematically illustrates a configuration example of acoustic system 100 including loudspeaker device 1 of the first exemplary embodiment. FIG. 1 is a perspective view of acoustic system 100 when acoustic system 100 is viewed from a front face side. In the first exemplary embodiment, it is assumed that a front face is a side on which operating part 110 of music player 101 is provided.

Acoustic system 100 includes one music player 101 and two loudspeaker devices 1. Quantities of music player 101 and loudspeaker device 1 are not limited to the above numerical values. Acoustic system 100 may include at least two music players 101. Acoustic system 100 may include one or at least three loudspeaker devices 1.

Loudspeaker device 1 is connected to music player 101, and can output (hereinafter, also simply referred to as “reproduce”) an audio signal output from music player 101 while transducing the audio signal into sound.

Music player 101 is configured to be able to transduce a signal output from various external devices or music sources into the audio signal reproducible with loudspeaker device 1, and output the audio signal. For example, music player 101 may be configured to receive a signal associated with the sound from an external device wired through a connection terminal of USB (UNIVERSAL Serial Bus) or an external device wirelessly connected by Wi-Fi (registered trademark) or Bluetooth (registered trademark), and output the audio signal. Alternatively, music player 101 may be configured to receive the signal associated with the sound from a CD (Compact Disc) player included in music player 101 or a music source such as a radio, and output the audio signal.

### [1-2. Configuration of Loudspeaker Device]

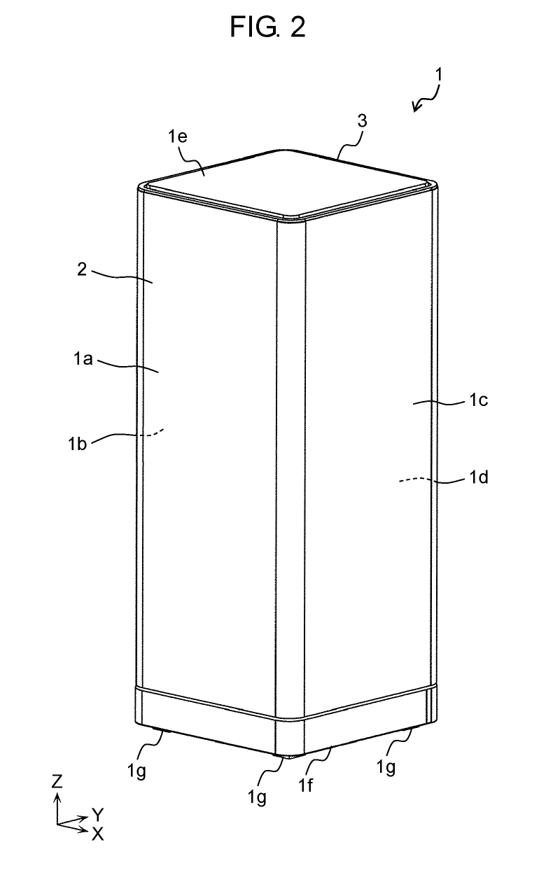

A configuration of loudspeaker device 1 of the first exemplary embodiment will be described below with reference to FIGS. 2 to 12.

FIG. 2 is a perspective view schematically illustrating a configuration example of loudspeaker device 1 of the first exemplary embodiment. FIG. 2 is a perspective view illustrating a front face of loudspeaker device 1 in FIG. 1 when loudspeaker device 1 is viewed in an oblique direction.

As illustrated in FIG. 2, loudspeaker device 1 has a rectangular parallelepiped shape that is longitudinal in a top-bottom direction (Z-axis direction). Loudspeaker device 1 is configured to be supported on a mounting surface (not illustrated) by a plurality of legs 1g provided in bottom face 1f. The first exemplary embodiment shows a configuration example where loudspeaker device 1 includes four legs 1g. However a number of legs 1g included in loudspeaker device 1 is not limited to four.

In loudspeaker device 1, top face 1e opposite to bottom face 1f is constructed with top board 3. Top board 3 also constitutes a design of loudspeaker device 1.

Loudspeaker device 1 includes top face 1e, bottom face 1f, and side face 1a, side face 1b, side face 1c, and side face 1d which are adjacent to top face 1e and bottom face 1f. In loudspeaker device 1, three side faces 1a, 1b, and 1c are constructed with exterior net 2. Exterior net 2 also constitutes the design of loudspeaker device 1. Side faces 1a, 1b, 1c , and 1d constituting the four side faces of the rectangular parallelepiped constitute a square cylinder.

In the first exemplary embodiment, for convenience, the description is made using three axes, namely, an X-axis, a Y-axis, and a Z-axis. It is assumed that a Z-axis positive direction is a direction from bottom face 1f toward top face 1e. It is assumed that a Y-axis positive direction is a direction from side face 1a that is the front face (hereinafter, also referred to as “front face 1a”) toward side face 1d that is the rear face (hereinafter, also referred to as “rear face 1d”). It is assumed that an X-axis positive direction is a direction from side face 1b toward side face 1c.

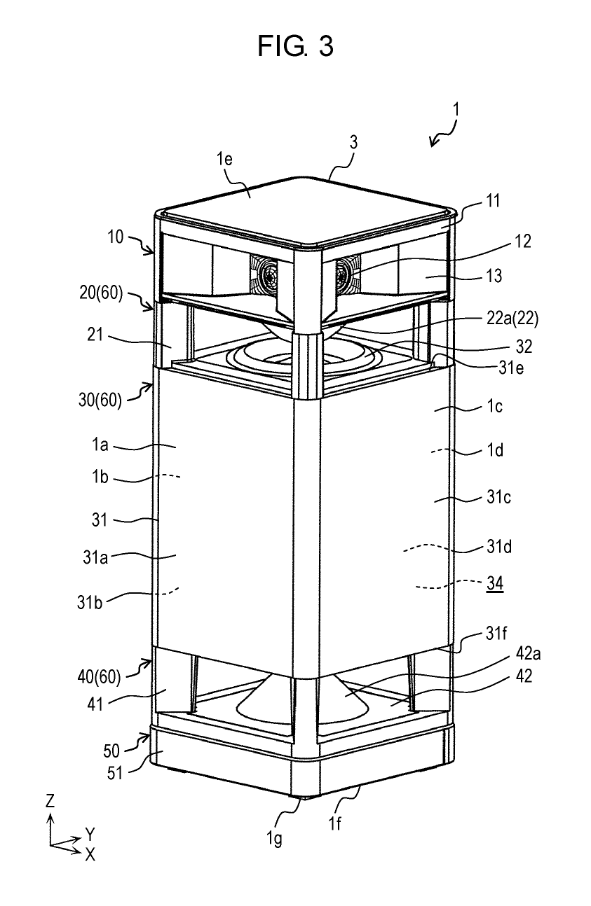

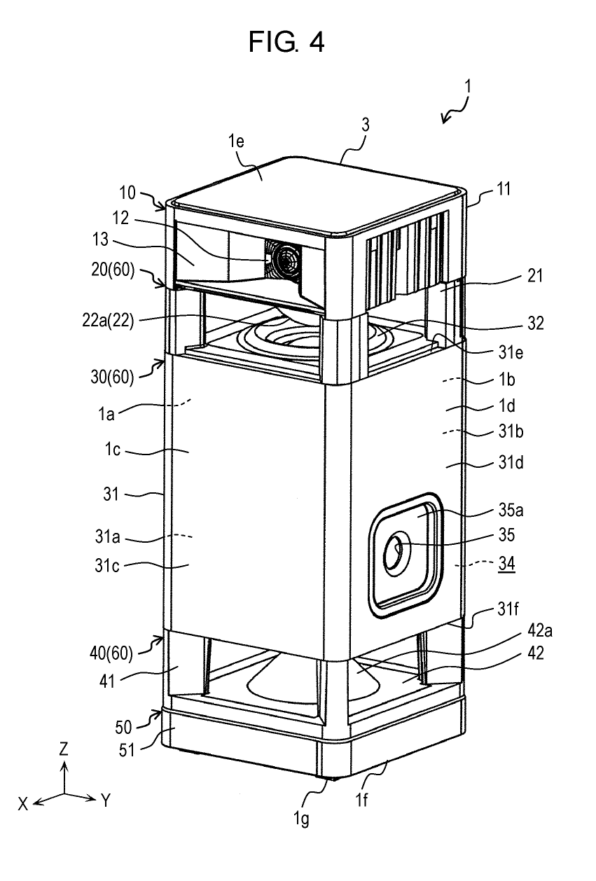

FIGS. 3 and 4 are perspective views schematically illustrating a configuration example of loudspeaker device 1 according to the first exemplary embodiment. FIG. 3 is a perspective view illustrating a state in which exterior net 2 is removed from loudspeaker device 1 in FIG. 2, and FIG. 4 is a perspective view illustrating a rear face of loudspeaker device 1 in FIG. 3 when loudspeaker device 1 is viewed in an oblique direction.

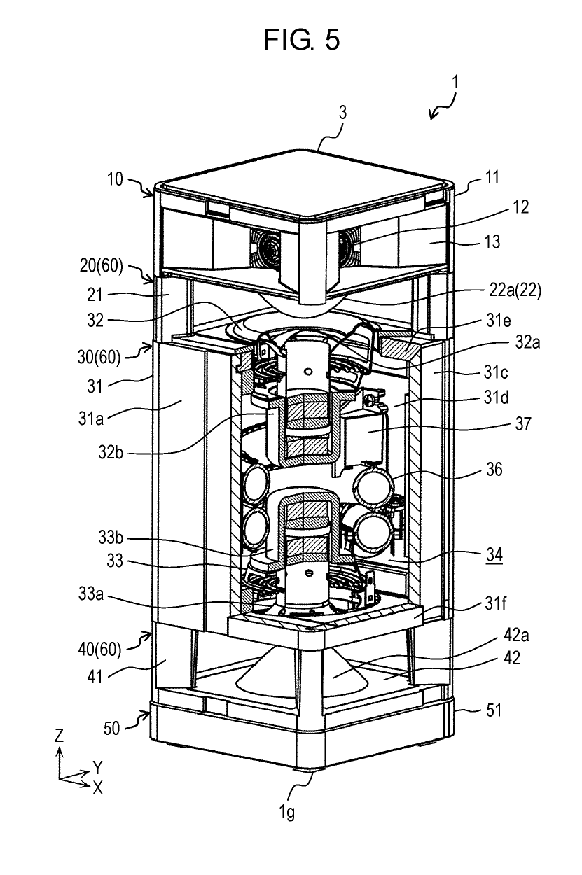

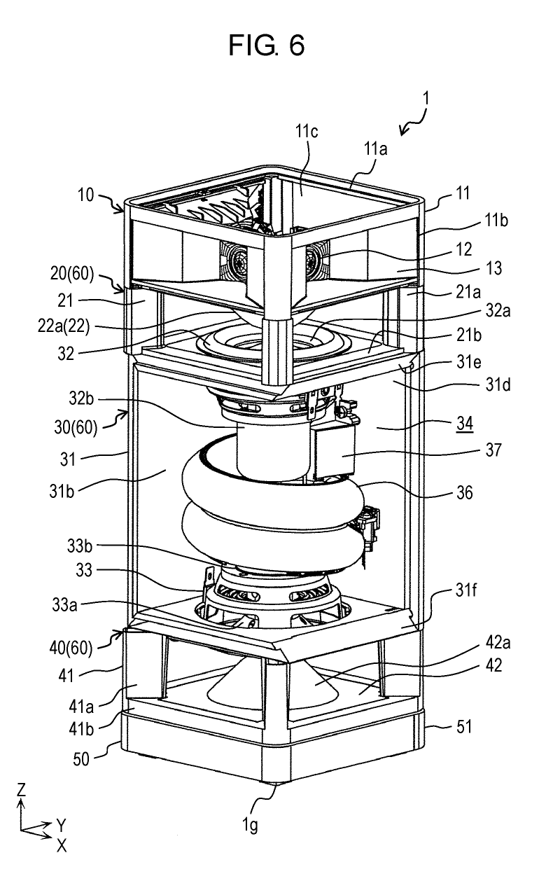

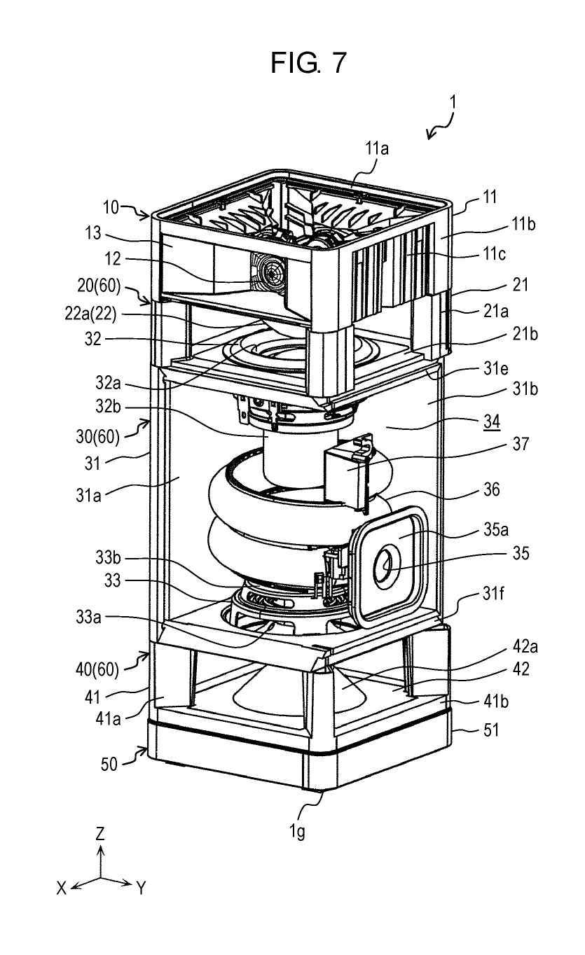

FIGS. 5, 6 and 7 are perspective views schematically illustrating an example of an internal structure of loudspeaker device 1 according to the first exemplary embodiment. FIG. 5 is a partial sectional view illustrating the internal structure of loudspeaker device 1 in FIG. 3 while loudspeaker device 1 is partially cut. FIG. 6 is a perspective view illustrating a state in which top board 3 and sidewalls 31a and 31c of loudspeaker housing 31 are removed from loudspeaker device 1 in FIG. 3. FIG. 7 is a perspective view illustrating a state in which top board 3 and sidewalls 31c and 31d of loudspeaker housing 31 are removed from loudspeaker device 1 in FIG. 4.

The following description will be made with reference to FIGS. 3 to 7. Loudspeaker device 1 includes tweeter 10, upper diffuser 20, woofer loudspeaker 30, lower diffuser 40, and pedestal 50. Tweeter 10 is disposed between top face 1e and upper diffuser 20, and includes a plurality of tweeter units 12. Upper diffuser 20, woofer loudspeaker 30, and lower diffuser 40 constitute woofer 60 in loudspeaker device 1. Woofer 60 is configured to take charge of reproduction of low-pitched to middle-pitched sounds in loudspeaker device 1. Tweeter 10 is configured to take charge of reproduction of middle-pitched to high-pitched sounds in loudspeaker device 1.

Tweeter frame 11 having a substantially rectangular parallelepiped contour is provided in tweeter 10. Substantially square frame-shaped upper edge 11a, four supports 11b separated from one another, and rectangular plate-shaped rear face wall 11c are integrally molded and included in tweeter frame 11. Each of four supports 11b is disposed so as to extend from each of four corners of upper edge 11a toward upper diffuser 20 in the Z-axis direction. Rear face wall 11c is disposed so as to extend between two supports 11b adjacent to each other on the side of rear face 1d. Rear face wall 11c closes a plane between two supports 11b on the side of rear face 1d. Upper edge 11a has a shape in which top board 3 is fitted while aligned with an inner periphery side of upper edge 11a.

In tweeter 10, three tweeter units 12, which are loudspeakers that can reproduce the high-pitched sound, are provided inside tweeter frame 11. Three tweeter units 12 are disposed so as to radially emit sound toward front face 1a, side face 1b, and side face 1c of loudspeaker device 1, respectively. That is, three tweeter units 12 are disposed such that orientations of tweeter units 12 are substantially orthogonal to one another on a plane (a horizontal direction, in the case that loudspeaker device 1 is mounted on the mounting surface parallel to a horizontal plane) substantially parallel to an XY-plane.

Tweeter unit 12 is configured to have a frequency characteristic of being able to reproduce sound having a frequency band of a predetermined high-pitched sound region. For example, the frequency band of the predetermined high-pitched sound region is a frequency range of 1 kHz to about 100 kHz or a frequency range of 2 kHz to 100 kHz or more. Note that, tweeter unit 12 is an example of the loudspeaker unit, and is also an example of the high-pitched loudspeaker unit.

In tweeter 10, directional control horn 13 is mounted on each tweeter unit 12. Directional control horn 13 is configured to have a trumpet shape, and to provide a directional characteristic to the sound reproduced with tweeter unit 12. Each of the plurality of directional control horns 13 extends from one tweeter unit 12, and a direction of each directional control horn 13 is set to a direction toward front face 1a, side face 1b, or side face 1c , which is an emission direction of the sound reproduced with the tweeter unit 12. Directional control horn 13 is opened between supports 11b of tweeter frame 11. Directional control horn 13 is disposed inside tweeter frame 11, and fixed to tweeter frame 11. In other words, one of three directional control horns 13 is disposed so as to radially emit the sound toward front face 1a, another one is disposed so as to radially emit the sound toward side face 1b, and the remaining one is disposed so as to radially emit the sound toward side face 1c. Note that, directional control horn 13 is an example of the horn.

Rectangular parallelepiped loudspeaker housing 31, in which the Z-axis direction is set to a longitudinal direction, is provided in woofer loudspeaker 30. Loudspeaker housing 31 has a hollow structure, and includes internal space 34. Woofer loudspeaker 30 includes upper woofer loudspeaker unit 32 and lower woofer loudspeaker unit 33. In loudspeaker housing 31, upper wall 31e and lower wall 31f are disposed in parallel to each other. Upper wall 31e is one oriented toward upper diffuser 20, and lower wall 31f is one oriented toward lower diffuser 40. Upper woofer loudspeaker unit 32 is embedded in an opening formed in upper wall 31e such that an output sound direction of upper woofer loudspeaker unit 32 is oriented toward upper diffuser 20. Lower woofer loudspeaker unit 33 is embedded in an opening formed in lower wall 31f such that an output sound direction of lower woofer loudspeaker unit 33 is oriented toward lower diffuser 40.

Upper woofer loudspeaker unit 32 and lower woofer loudspeaker unit 33 are configured to have a frequency characteristic of being able to suitably reproduce sound having a frequency band of a predetermined middle-pitched and low-pitched sound region. For example, the frequency band of the predetermined middle-pitched and low-pitched sound region is a frequency range of 35 Hz to 5000 Hz. Note that, loudspeaker housing 31 is an example of the low-pitched loudspeaker housing.

As described above, a mounting direction of upper woofer loudspeaker unit 32 is set such that upper woofer loudspeaker unit 32 emits the sound toward upper diffuser 20, and a mounting direction of lower woofer loudspeaker unit 33 is set such that lower woofer loudspeaker unit 33 emits the sound toward lower diffuser 40. When upper woofer loudspeaker unit 32 and lower woofer loudspeaker unit 33 are provided on woofer loudspeaker 30, a relatively large sound pressure can be obtained in woofer loudspeaker 30 even if each of upper woofer loudspeaker unit 32 and lower woofer loudspeaker unit 33 includes diaphragm 32a or diaphragm 33a (see FIG. 5) having a relatively small diameter of, for example, about 8 cm.

Furthermore, upper woofer loudspeaker unit 32 is provided in upper wall 31e of loudspeaker housing 31 and lower woofer loudspeaker unit 33 is provided in lower wall 31f of loudspeaker housing 31. Therefore, loudspeaker housing 31 can be miniaturized in the XY-plane, and a mounting area of loudspeaker device 1 can be reduced. Note that, each of upper woofer loudspeaker unit 32 and lower woofer loudspeaker unit 33 is an example of the low-pitched loudspeaker unit.

Upper frame 21 having a substantially rectangular parallelepiped contour is provided in upper diffuser 20. Upper frame 21 includes four supports 21a and substantially square plate-shaped support plate 21b. Four supports 21a are formed so as to be disposed while separated from one another, and extend in the Z-axis direction. Support plate 21b and four supports 21a are formed so as to be integrally molded. Four supports 21a are disposed in four corners of a square upper wall 31e of loudspeaker housing 31, respectively, and at four supports 11b of tweeter frame 11, respectively. Support plate 21b is formed so as to extend along upper wall 31e. Upper woofer loudspeaker unit 32 is disposed through the opening formed in support plate 21b, and diaphragm 32a of upper woofer loudspeaker unit 32 is exposed in upper frame 21. Support plate 21b is fixed to upper wall 31e of loudspeaker housing 31, supports 21a are fixed to tweeter frame 11, whereby upper frame 21 couples tweeter 10 and woofer loudspeaker 30 together.

In upper diffuser 20, diffuser body 22 is provided in upper frame 21. Diffuser body 22 includes conically projecting diffusion part 22a. Diffuser body 22 is disposed adjacent to tweeter frame 11, and fixed to support 21a of upper frame 21. Diffusion part 22a has an external form in which a tip of a cone is rounded, and has a hollow structure in which an opposite side to the tip is opened. The tip of diffusion part 22a projects toward upper woofer loudspeaker unit 32, and diffusion part 22a is disposed so as to face the center of diaphragm 32a of upper woofer loudspeaker unit 32. Accordingly, diffusion part 22a substantially uniformly diffuses the sound reproduced with upper woofer loudspeaker unit 32 in a direction along the XY-plane around loudspeaker device 1. For example, when loudspeaker device 1 is mounted on the mounting surface parallel to the horizontal plane, diffusion part 22a substantially nondirectionally diffuses the sound reproduced with upper woofer loudspeaker unit 32 over 360 degrees in the horizontal direction.

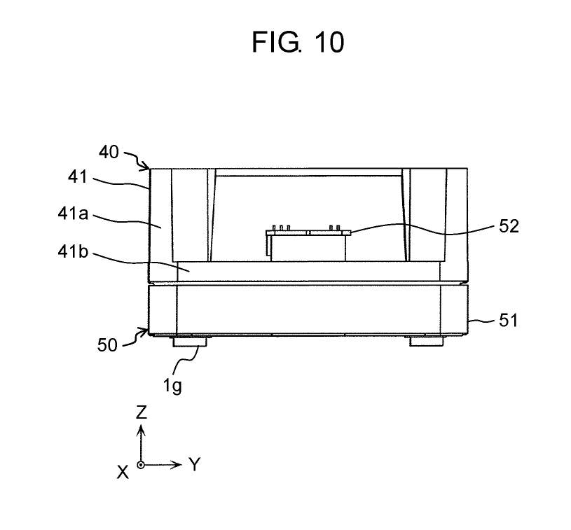

FIG. 10 is a side view schematically illustrating a configuration example of pedestal 50 included in loudspeaker device 1 of the first exemplary embodiment and a periphery of pedestal 50. Although diffuser body 42 is mounted on the pedestal 50 as illustrated in FIG. 5, FIG. 10 illustrates pedestal 50 in which the diffuser body 42 is removed.

Box-shaped pedestal housing 51 is provided in pedestal 50. Pedestal housing 51 has a square shape in a planar view, and is flat in the Z-axis direction. A plurality of legs 1g and a connection plug (not illustrated) are provided in a bottom portion of pedestal housing 51. The connection plug is a connection member that electrically connects music player 101 and loudspeaker device 1 in FIG. 1 to each other. As illustrated in FIG. 10, circuit board 52 is provided inside pedestal housing 51, and a circuit that controls operation of upper woofer loudspeaker unit 32 and lower woofer loudspeaker unit 33 is mounted on circuit board 52. Circuit board 52 is disposed so as to project in lower diffuser 40, and electrically connected to the connection plug. A weight (not illustrated) may be provided in pedestal housing 51 in order to improve stability of loudspeaker device 1 mounted on a mounting surface such as a floor.

The description will be made again with reference to FIGS. 3 to 7.

Lower frame 41 having a substantially rectangular parallelepiped contour is provided in lower diffuser 40. Lower frame 41 includes four supports 41a and four beams 41b. Four supports 41a are formed so as to be disposed while separated from one another, and extended in the Z-axis direction. Each of four beams 41b couples adjacent supports 41a together. Four supports 41a are disposed in four corners of a square lower wall 31f of loudspeaker housing 31, respectively, and in four corners at the sides of pedestal housing 51, respectively. Four beams 41b are disposed at ends of supports 41a on the side of pedestal housing 51, respectively, and extend along outer edges of the pedestal housing 51. When supports 41a are fixed to lower wall 31f of loudspeaker housing 31 and pedestal housing 51, lower frame 41 couples woofer loudspeaker 30 and pedestal 50 together.

In lower diffuser 40, diffuser body 42 is provided in lower frame 41. Diffuser body 42 includes conically projecting diffusion part 42a. Diffusion part 42a has an external form in which the tip of the cone is rounded, and has a hollow structure in which the opposite side to the tip is opened. Diffuser body 42 has a shape similar to diffuser body 22. Diffuser body 42 is disposed adjacent to pedestal housing 51, and fixed to beams 41b of lower frame 41. The tip of diffusion part 42a projects toward lower woofer loudspeaker unit 33, and diffusion part 42a is disposed so as to face the center of diaphragm 33a of lower woofer loudspeaker unit 33. Accordingly, diffusion part 42a substantially uniformly diffuses the sound reproduced with lower woofer loudspeaker unit 33 in the direction along the XY-plane around loudspeaker device 1. For example, when loudspeaker device 1 is mounted on the mounting surface parallel to the horizontal plane, diffusion part 42a substantially nondirectionally diffuses the sound reproduced with lower woofer loudspeaker unit 33 over 360 degrees in the horizontal direction.

The detailed configuration of woofer loudspeaker 30 will be described with reference to FIGS. 3 to 5.

In addition to upper wall 31e and lower wall 31f, loudspeaker housing 31 of woofer loudspeaker 30 includes sidewalls 31a, 31b, 31c, and 31d that are adjacent to upper wall 31e and lower wall 31f. Sidewall 31a is located in front face 1a of loudspeaker device 1, sidewall 31b is located in side face 1b, sidewall 31c is located in side face 1c, and sidewall 31d is located in rear face 1d.

Closed internal space 34 surrounded by upper woofer loudspeaker unit 32, lower woofer loudspeaker unit 33, sidewalls 31a to 31d, upper wall 31e, and lower wall 31f are formed inside loudspeaker housing 31. In upper woofer loudspeaker unit 32 and lower woofer loudspeaker unit 33, for example, as illustrated in FIG. 5, diaphragm 32a and diaphragm 33a are disposed so as to face internal space 34 and the outside of loudspeaker housing 31, respectively. Upper woofer loudspeaker unit 32 and lower woofer loudspeaker unit 33 are disposed in internal space 34 while separated from each other in the Z-axis direction. For example, internal space 34 may have a relatively small volume of about 800 cubic centimeters as a volume of the loudspeaker housing.

As shown in the example of FIG. 4, acoustic port 35 is formed in sidewall 31d (hereinafter, also referred to as a “rear-face-side sidewall 31d”) located in rear face 1d. Acoustic port 35 is a bass reflex port opened circularly. Port plate 35a fitted in rear-face-side sidewall 31d is circularly pierced to form acoustic port 35.

The following description will be made with reference to FIGS. 5 to 9.

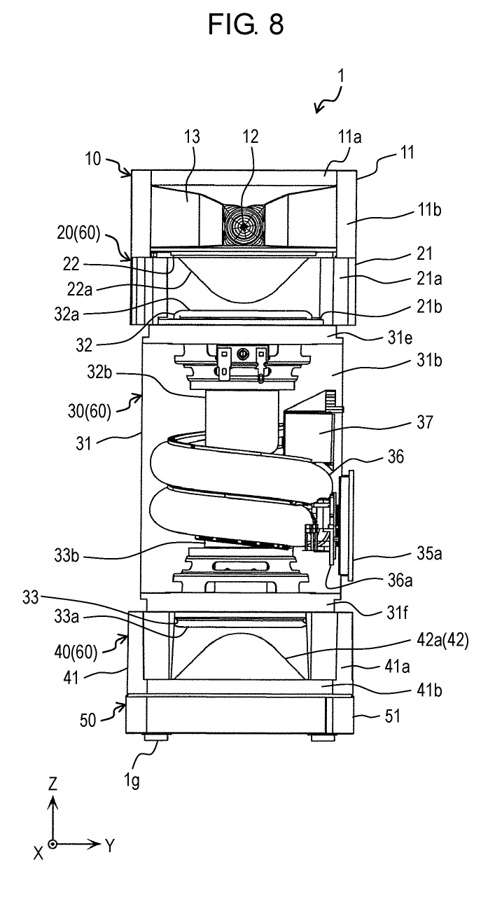

FIG. 8 is a side view schematically illustrating an example of the internal structure of loudspeaker device 1 of the first exemplary embodiment. FIG. 8 is a side view illustrating loudspeaker device 1 in FIG. 7, in which sidewall 31a of loudspeaker housing 31 is removed, when loudspeaker device 1 is viewed from the side of sidewall 31c.

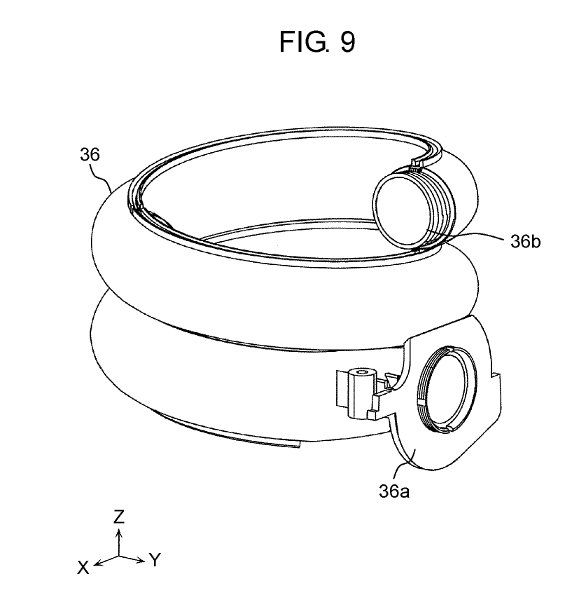

FIG. 9 is a perspective view schematically illustrating a configuration example of acoustic tube 36 of loudspeaker device 1 of the first exemplary embodiment. FIG. 9 illustrates single acoustic tube 36 of loudspeaker device 1 shown in FIG. 7.

In internal space 34 of loudspeaker housing 31, acoustic tube 36 having a circular section is provided between upper woofer loudspeaker unit 32 and lower woofer loudspeaker unit 33. Acoustic tube 36 is formed so as to extend spirally around upper woofer loudspeaker unit 32 and lower woofer loudspeaker unit 33. Specifically, acoustic tube 36 has a shape going around cylindrical vibrator generator (also referred to as a magnetic circuit) 32b that drives diaphragm 32a of upper woofer loudspeaker unit 32 and cylindrical vibrator generator (magnetic circuit) 33b that drives diaphragm 33a of lower woofer loudspeaker unit 33. Structures that vibrate diaphragms 32a and 33a according to the audio signal are disposed in vibrator generators (magnetic circuits) 32b and 33b.

For example, acoustic tube 36 may be formed into a spiral shape having a smooth bending angle. Furthermore, acoustic tube 36 may be formed while uniformly bent. Furthermore, acoustic tube 36 may be formed so as to have an outer diameter as large as possible to an extent that comes into contact with sidewalls 31a, 31b, 31c, and 31d of loudspeaker housing 31. In the first exemplary embodiment, acoustic tube 36 is formed so as to have the large outer diameter coming close to sidewalls 31a, 31b, 31c, and 31d.

Flange 36a located at one end of acoustic tube 36 is coupled to port plate 35a (see FIGS. 4 and 9). Acoustic tube 36 has the substantially same inner diameter as the acoustic port 35, and is communicated to acoustic port 35. End 36b which is the other end of acoustic tube 36 is opened to internal space 34 of loudspeaker housing 31. Acoustic tube 36 and acoustic port 35 communicate the outside of loudspeaker housing 31 and internal space 34 to each other. The opening at end 36b of acoustic tube 36 is covered with sound absorbing material 37 (acoustic absorber) (see FIG. 6). Sound absorbing material 37 is configured to have a function of damping and absorbing the sound. For example, sound absorbing material 37 is made from a material such as polyester. Sound absorbing material 37 functions to damp a resonance caused by a length (that is, a port length) of acoustic tube 36. That is, sound absorbing material 37 has an effect that damps the resonance caused by the port length. Acoustic tube 36 is fixed to sidewall 31d on the rear face side of loudspeaker housing 31 via port plate 35a and a frame member of sound absorbing material 37. Sound absorbing material 37 is not necessarily provided.

Upper woofer loudspeaker unit 32, lower woofer loudspeaker unit 33, acoustic port 35, acoustic tube 36, and loudspeaker housing 31 constitute the bass reflex type loudspeaker. In loudspeaker device 1 that is the bass reflex type loudspeaker, a spring characteristic of air in internal space 34 and acoustic mass of acoustic tube 36 and acoustic port 35 can resonate by receiving the vibrations of diaphragm 32a of upper woofer loudspeaker unit 32 and diaphragm 33a of lower woofer loudspeaker unit 33. That is, loudspeaker device 1 can perform the bass reflex resonance.

In the case that the resonance is not generated, the sound radiated to the front faces of diaphragms 32a and 33a and the sound radiated to the rear faces of diaphragms 32a and 33a are opposite to each other in a phase. On the other hand, in loudspeaker device 1, a phase rotation of the sound radiated to the rear faces of diaphragms 32a and 33a is generated by the bass reflex resonance. Therefore, air resonating near a bass reflex resonance frequency in internal space 34 is composed with air emitted from diaphragms 32a and 33a toward a direction of diffuser body 22 and diffuser body 42. This enables the sound pressure to be enhanced in loudspeaker device 1. The resonating air can occasionally reduce excursions of diaphragms 32a and 33a. The bass reflex resonance frequency is a resonance frequency in the bass reflex resonance.

Bass reflex resonance frequency Fb is given by the following equation.

Fb=((1/M·C)̂(1/2))/2π

(A symbol of ̂expresses exponential)

Note that, M is an element associated with the acoustic mass of acoustic tube 36, and C is an element associated with the volume of internal space 34. The bass reflex resonance can effectively increase the sound pressures of diaphragms 32a and 33a, and effectively decrease the excursions of diaphragm 32a and 33a.

In the first exemplary embodiment, in order to increase the sound pressures in deep low-pitched sound regions of upper woofer loudspeaker unit 32 and lower woofer loudspeaker unit 33, the bass reflex resonance frequency is set to a predetermined frequency in the deep low-pitched sound region, which is lower than or equal to a frequency band in which upper woofer loudspeaker unit 32 and lower woofer loudspeaker unit 33 can suitably reproduce the sound. In this case, it is necessary to increase elements M and C to correspond to the low bass reflex resonance frequency. For example, the predetermined frequency in the deep low-pitched sound region can be set to, but not limited to, a range of 30 Hz to 50 Hz and a frequency band of the sound near the range.

In the first exemplary embodiment, elements M and C corresponding to the bass reflex resonance frequency are decided while element C is relatively decreased. Specifically, for example, a volume of internal space 34 associated with element C is previously set to the relatively small volume of about 800 cubic centimeters, and element M is relatively increased. That is, in the first exemplary embodiment, acoustic tube 36 is configured such that the acoustic mass of acoustic tube 36 is relatively increased. In order to increase the acoustic mass, acoustic tube 36 is configured such that the inner diameter is relatively small while the tube length is relatively long.

A noise is easily generated when an air speed in tube, which is an air speed in acoustic tube 36, increases. Therefore, the acoustic tube 36 may be configured such that a frequency at which the air speed in tube is maximized by the bass reflex resonance becomes a predetermined frequency (for example, a frequency of an ultra low-pitched sound region hardly included in the sound and music signal). At this point, acoustic tube 36 is configured such that the tube length is relatively long. For example, the ultra low-pitched sound region can be set to a range of 10 Hz to 30 Hz and a frequency band of the sound near the range.

In the description above, the inner diameter of acoustic tube 36 is set to be relatively small in order to increase the acoustic mass. However, the inner diameter of acoustic tube 36 is also set in consideration of suppressing a resistance against the air passing through the long acoustic tube 36.

The inner diameter and tube length of acoustic tube 36 are decided based on the above conditions. For example, in the first exemplary embodiment, in the case that the volume of internal space 34 is set to 800 cubic centimeters while the bass reflex resonance frequency is set to 40 Hz, the inner diameter of acoustic tube 36 can be set to 16 mm while tube length can be set to 450 mm. Acoustic tube 36 is bent in order that the relatively long acoustic tube 36 is accommodated in the relatively small internal space 34.

The configurations of acoustic tube 36 and internal space 34 can suppress the excursions of diaphragm 32a of upper woofer loudspeaker unit 32 and diaphragm 33a of lower woofer loudspeaker unit 33 at the bass reflex resonance frequency and in the frequency band near the bass reflex resonance frequency. In the case that the excursions of diaphragms 32a and 33a are relatively decreased at the bass reflex resonance frequency and in the frequency band near the bass reflex resonance frequency, boost control is performed on upper woofer loudspeaker unit 32 and lower woofer loudspeaker unit 33 such that the sound pressure is electrically increased in the frequency band, which allows distortion to be suppressed in the reproduced sound. On the other hand, when the above boost control is performed on upper woofer loudspeaker unit 32 and lower woofer loudspeaker unit 33 while the excursions of diaphragms 32a and 33a are relatively large at the bass reflex resonance frequency and in the frequency band near the bass reflex resonance frequency, the sound includes the distortion.

Acoustic tube 36 and acoustic port 35 may be formed into a smooth shape, such as a circular shape, in order to decrease a viscous resistance of the inner surfaces of acoustic tube 36 and acoustic port 35.

In the case that acoustic tube 36 is relatively abruptly bent, a frictional noise (that is, air-cut noise) of the air flowing through acoustic tube 36 is relatively increased. In order to suppress the air-cut noise, the acoustic tube 36 may relatively smoothly bent, and the bending angle and bending radius of the acoustic tube 36 may be relatively large. Acoustic tube 36 may uniformly be bent. For example, as shown in the first exemplary embodiment, acoustic tube 36 has the outer diameter enough to be inscribed in sidewalls 31a, 31b, 31c, and 31d of loudspeaker housing 31, and is formed into a spirally extending shape, which allows loudspeaker device 1 to satisfy the above conditions. When acoustic tube 36 is formed into the spiral shape, a region occupied by acoustic tube 36 in internal space 34 can be reduced.

Because acoustic tube 36 is disposed so as to be interposed between diaphragm 32a of upper woofer loudspeaker unit 32 and diaphragm 33a of lower woofer loudspeaker unit 33, acoustic tube 36 can diffuse vibration waves of diaphragms 32a and 33a, and suppress interference between the vibration waves. Therefore, generation of a standing wave caused by the interference between the vibration waves of diaphragms 32a and 33a can be reduced. Preferably, the standing wave is suppressed because the standing wave has an influence on the resonance of the air in internal space 34.

The circuit mounted on circuit board 52 shown in FIG. 10 can not only control the operation of upper woofer loudspeaker unit 32 and lower woofer loudspeaker unit 33, but also perform control for electrically boosting operation of upper woofer loudspeaker unit 32 and lower woofer loudspeaker unit 33. Specifically, in a frequency band in which the excursions of diaphragm 32a of upper woofer loudspeaker unit 32 and diaphragm 33a of lower woofer loudspeaker unit 33 are decreased by the bass reflex resonance, the circuit mounted on circuit board 52 increases signal voltages applied to upper woofer loudspeaker unit 32 and lower woofer loudspeaker unit 33, thereby performing boost control in order to increase the sound pressures of diaphragms 32a and 33a.

Woofer 60 including upper diffuser 20, woofer loudspeaker 30, and lower diffuser 40, which have the above configurations, can reproduce the low-pitched sound with low distortion similarly to a loudspeaker including a large-diameter diaphragm, even if upper woofer loudspeaker unit 32 includes relatively small-diameter diaphragm 32a, and even if lower woofer loudspeaker unit 33 includes relatively small-diameter diaphragm 33a.

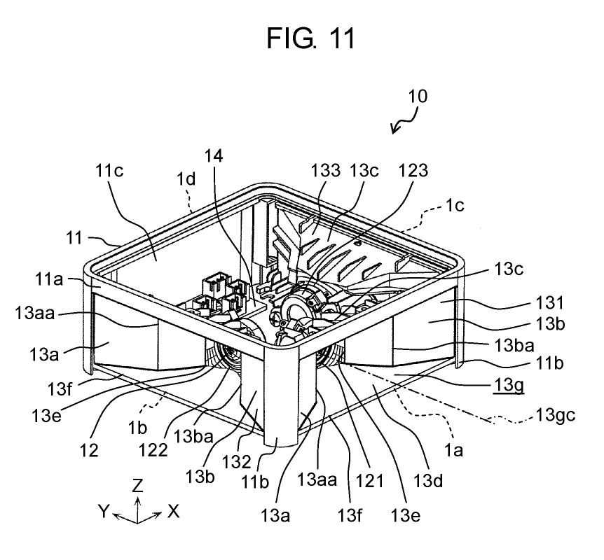

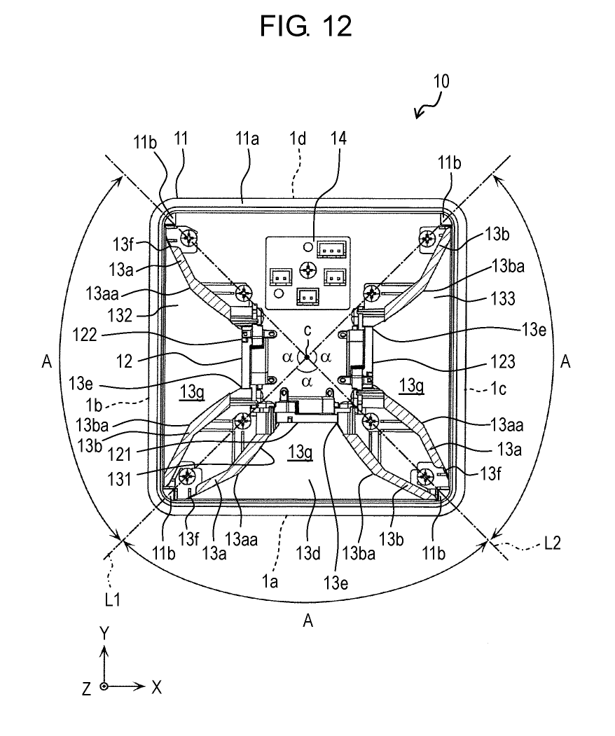

The detailed configuration of tweeter 10 will be described with reference to FIGS. 11 and 12.

FIG. 11 is a perspective view schematically illustrating a configuration example of tweeter 10 included in loudspeaker device 1 of the first exemplary embodiment. FIG. 11 is a perspective view illustrating tweeter 10 of loudspeaker device 1 in FIG. 6 when tweeter 10 is viewed in a direction different from the direction in which tweeter 10 is viewed in FIG. 6.

FIG. 12 is a top view schematically illustrating a configuration example of tweeter 10 included in loudspeaker device 1 of the first exemplary embodiment. FIG. 12 is a top view of tweeter 10 in FIG. 11 when tweeter 10 is viewed from above, illustrating tweeter 10 in which upper wall 13c of directional control horn 13 is removed.

Tweeter circuit board 14 on which a circuit controlling tweeter unit 12 is mounted is provided in tweeter frame 11 in addition to three tweeter units 12 and three directional control horns 13. Tweeter circuit board 14 is mounted on upper frame 21 of upper diffuser 20 shown in FIG. 6. The circuit mounted on tweeter circuit board 14 is electrically connected to three tweeter units 12, and configured to control operation of tweeter units 12. Hereinafter, for convenience, each of three tweeter units 12 are also referred to as first tweeter unit 121, second tweeter unit 122, and third tweeter unit 123. Three directional control horns 13 respectively mounted on first tweeter unit 121, second tweeter unit 122, and third tweeter unit 123 are also referred to as first directional control horn 131, second directional control horn 132, and third directional control horn 133, respectively.

First tweeter unit 121 and first directional control horn 131 are oriented toward front face 1a of loudspeaker device 1, second tweeter unit 122 and second directional control horn 132 are oriented toward side face 1b of loudspeaker device 1, and third tweeter unit 123 and third directional control horn 133 are oriented toward side face 1c of loudspeaker device 1. Accordingly, first tweeter unit 121 and first directional control horn 131, second tweeter unit 122 and second directional control horn 132, and third tweeter unit 123 and third directional control horn 133 are disposed such that orientations of first tweeter unit 121 and first directional control horn 131, orientations of second tweeter unit 122 and second directional control horn 132, and orientations of third tweeter unit 123 and third directional control horn 133 are substantially orthogonal to one another in a plane (the horizontal direction, in the case that loudspeaker device 1 is mounted on the mounting surface parallel to the horizontal plane) substantially parallel to the XY-plane. Second tweeter unit 122 and second directional control horn 132, and third tweeter unit 123 and third directional control horn 133 are disposed such that the orientations of second tweeter unit 122 and second directional control horn 132 and the orientations of third tweeter unit 123 and third directional control horn 133 are substantially opposite to each other. Note that, first tweeter unit 121 is an example of the first loudspeaker unit, second tweeter unit 122 is an example of the second loudspeaker unit, and third tweeter unit 123 is an example of the third loudspeaker unit. First directional control horn 131 is an example of the first horn, second directional control horn 132 is an example of the second horn, and third directional control horn 133 is an example of the third horn.

Each of first directional control horn 131, second directional control horn 132, and third directional control horn 133 includes fan-shaped bottom wall 13d disposed on the side of upper diffuser 20 (see FIG. 6), fan-shaped upper wall 13c disposed at a position facing bottom wall 13d, and sidewalls 13a and 13b disposed between upper wall 13c and bottom wall 13d. Upper wall 13c and bottom wall 13d are substantially symmetrical like a mirror image. Sidewalls 13a and 13b are substantially symmetrical like a mirror image.

First directional control horn 131, second directional control horn 132, and third directional control horn 133 are formed into a trumpet shape having a rectangular section by sidewall 13a, sidewall 13b, upper wall 13c, and bottom wall 13d.

Sidewall 13a, sidewall 13b, upper wall 13c, and bottom wall 13d of first directional control horn 131 constitute opening 13e in which first tweeter unit 121 is mounted and opening 13f on the side of front face 1a that is the emission direction of the sound reproduced with first tweeter unit 121.

Sidewall 13a, sidewall 13b, upper wall 13c, and bottom wall 13d of second directional control horn 132 constitute opening 13e in which second tweeter unit 122 is mounted and opening 13f on the side of side face 1b that is the emission direction of the sound reproduced with second tweeter unit 122.

Sidewall 13a, sidewall 13b, upper wall 13c, and bottom wall 13d of third directional control horn 133 constitute opening 13e in which third tweeter unit 123 is mounted and opening 13f on the side of side face 1c that is the emission direction of the sound reproduced with third tweeter unit 123.

On the insides of first directional control horn 131, second directional control horn 132, and third directional control horn 133, diffusion path 13g spreading from opening 13e toward opening 13f in the trumpet shape is formed by sidewall 13a, sidewall 13b, upper wall 13c, and bottom wall 13d. Note that, bottom wall 13d is an example of the first wall of the horn, and upper wall 13c is an example of the second wall of the horn.

Each of first directional control horn 131, second directional control horn 132, and third directional control horn 133 is oriented such that central axis 13gc of each of diffusion paths 13g is set along the XY-plane. In FIG. 11, only central axis 13gc of diffusion path 13g of first directional control horn 131 is indicated by an alternate long and short dash line, and other central axes 13gc are omitted to be illustrated. Central axis 13gc is an axis that is equidistant from each of sidewalls 13a and 13b, and is also equidistant from each of upper wall 13c and bottom wall 13d. Accordingly, when loudspeaker device 1 is mounted on the mounting surface parallel to the horizontal plane, each of central axes 13gc of first directional control horn 131, second directional control horn 132, and third directional control horn 133 is substantially parallel to the horizontal plane. That is, when loudspeaker device 1 is used in a usual operating state, central axes 13gc of first directional control horn 131, second directional control horn 132, and third directional control horn 133 are substantially parallel to the horizontal direction.

Upper wall 13c of each of first directional control horn 131, second directional control horn 132, and third directional control horn 133 is inclined onto the opposite side (on the side of top board 3) to upper diffuser 20 such that diffusion path 13g spreads in the Z-axis direction from opening 13e toward opening 13f. A width of each upper wall 13c is increased such that diffusion path 13g expands along the XY-plane from opening 13e toward opening 13f. In opening 13f, the width of each upper wall 13c expands to two adjacent supports 11b.

Bottom wall 13d of each of first directional control horn 131, second directional control horn 132, and third directional control horn 133 is inclined onto the side of upper diffuser 20 such that diffusion path 13g spreads in the Z-axis direction from opening 13e toward opening 13f. The width of each bottom wall 13d is increased such that diffusion path 13g expands along the XY-plane from opening 13e toward opening 13f. In opening 13f, the width of each bottom wall 13d expands to two adjacent supports 11b.

Bottom wall 13d may be formed, from opening 13e toward opening 13f, so as not to be inclined onto the side of upper diffuser 20, but to be substantially parallel to the XY-plane. Alternatively, bottom wall 13d may be formed so as to be inclined onto the opposite side to upper diffuser 20. In the first exemplary embodiment, upper wall 13c is inclined onto the opposite side to upper diffuser 20 from opening 13e toward opening 13f. Accordingly, when loudspeaker device 1 is mounted on the mounting surface substantially parallel to the horizontal plane, namely, when loudspeaker device 1 is used in the usual operating state, directional control horn 13 directs the sound reproduced with tweeter unit 12 in a Z-axis upward direction from bottom wall 13d toward upper wall 13c.

Sidewalls 13a and 13b of each of first directional control horn 131, second directional control horn 132, and third directional control horn 133, diffusion path 13g is formed along edges of upper wall 13c and bottom wall 13d such that diffusion path 13g expands along the XY-plane from opening 13e toward opening 13f. Sidewall 13a includes bent portion 13aa in the middle from opening 13e toward opening 13f, and sidewall 13b includes bent portion 13ba in the middle from opening 13e toward opening 13f. Sidewalls 13a and 13b are bent in bent portions 13aa and 13ba respectively so as to be farther separated from each other from opening 13e toward opening 13f. Accordingly, as to a rate of increase in width of diffusion path 13g from opening 13e toward opening 13f, the rate of increase in width from bent portions 13aa and 13ba to opening 13f is larger than the rate of increase in width from opening 13e to bent portions 13aa and 13ba.

Each of first directional control horn 131, second directional control horn 132, and third directional control horn 133, which have the above configurations, can diffuse the sounds reproduced with each of first tweeter unit 121, second tweeter unit 122, and third tweeter unit 123 in the direction (the direction along the XY-plane) along the sidewalls 13a and 13b and the direction (Z-axis direction) along upper wall 13c and bottom wall 13d. Each of first directional control horn 131, second directional control horn 132, and third directional control horn 133 includes bent sidewalls 13a and 13b, so that a directional range of the sound can be controlled in the direction along the XY-plane (for example, the horizontal direction). That is, each of first directional control horn 131, second directional control horn 132, and third directional control horn 133 can control the directional characteristics of the sounds reproduced with each of first tweeter unit 121, second tweeter unit 122, and third tweeter unit 123 such that the sound is diffused while a most part of the sound is restricted to the directional range of a predetermined directional angle (for example, 90 degrees with respect to the horizontal direction).

This operation will specifically be described with reference to FIG. 12. As illustrated in FIG. 12, first directional control horn 131 is configured to diffuse the sound reproduced with first tweeter unit 121 while restricting the most part of the sound to directional range A of directional angle α in the direction along the XY-plane, second directional control horn 132 is configured to diffuse the sound reproduced with second tweeter unit 122 while restricting the most part of the sound to directional range A of directional angle α in the direction along the XY-plane, third directional control horn 133 is configured to diffuse the sound reproduced with third tweeter unit 123 while restricting the most part of the sound to directional range A of directional angle α in the direction along the XY-plane. In the first exemplary embodiment, directional range A may be set to a region between line segment L1 and line segment L2 with respect to each of first directional control horn 131, second directional control horn 132, and third directional control horn 133. Line segments L1 and L2 are those that pass from diffusion reference point C to both ends of opening 13f, specifically, the center of support 11b. Diffusion reference point C is a virtual point that is set to the rear of first tweeter unit 121, second tweeter unit 122, and third tweeter unit 123. In FIG. 12, line segment L1 and line segment L2 are indicated by an alternate long and dash line. Directional angle α is one formed between line segment L1 and line segment L2.

In the first exemplary embodiment, directional angle α is set to 90 degrees. In designing directional control horn 13 (first directional control horn 131, second directional control horn 132, and third directional control horn 133) having directional angle α, it is not always necessary to design to direct the sound at all frequencies into directional range A of directional angle α. Each of first directional control horn 131, second directional control horn 132, and third directional control horn 133 may be designed to direct the sound having the frequency reproducible with tweeter unit 12 (first tweeter unit 121, second tweeter unit 122, or third tweeter unit 123), the sound having the frequency suitably reproducible with tweeter unit 12, or the sound having the frequency usually reproduced with tweeter unit 12 into directional range A.

First directional control horn 131, second directional control horn 132, and third directional control horn 133 are disposed such that directional range A of each of first directional control horn 131, second directional control horn 132, and third directional control horn 133 does not substantially overlap each other in the direction along the XY-plane, but is adjacent to each other. This suppresses interference among the sounds reproduced with first tweeter unit 121, second tweeter unit 122, and third tweeter unit 123, which are emitted through first directional control horn 131, second directional control horn 132, and third directional control horn 133. Resultantly, loudspeaker device 1 can emit the sounds reproduced with first tweeter unit 121, second tweeter unit 122, and third tweeter unit 123 with a continuous, substantially uniform sound pressure in the directions of front face 1a, side face 1b, and side face 1c of loudspeaker device 1 except for rear face 1d, namely, in the directional range extending over 270 degrees in XY-plane. That is, loudspeaker device 1 used in the normal operating state can reproduce the substantially nondirectional sound over 270 degrees in the horizontal direction.

The term “directional range A of each of first directional control horn 131, second directional control horn 132, and third directional control horn 133 does not substantially overlap each other, but is adjacent to each other” includes the following three cases.

The first case is a case in which a gap exists slightly between directional ranges A which are adjacent to each other. However, the gap has a size such that the change of the sound pressure, sound quality and the like do not appear substantially as a measurement result between directional range A and a region of the gap.

The second case is a case in which adjacent directional ranges A are directly adjacent to each other without a gap and an overlap.

The third case is a case in which adjacent directional ranges A slightly overlap each other. However, the overlap has a size such that the changes in the sound pressure, sound quality, and the like caused by the interference in the overlapping region do not appear substantially as a measurement result when compared to directional range A.

### [1-3. Practical Example of Loudspeaker Device]

Practical example 1 of loudspeaker device 1 of the first exemplary embodiment and comparative example 1 of a loudspeaker device that is not of the bass reflex type but a sealed type were compared to each other with respect to a characteristic of the woofer.

In woofer 60 of practical example 1, loudspeaker housing 31 had the inner volume of 800 cubic centimeters, acoustic port 35 and acoustic tube 36 had the diameter of 16 mm, and acoustic tube 36 had the length of 450 mm. Upper woofer loudspeaker unit 32 and lower woofer loudspeaker unit 33 had the diameter of 8 cm and the frequency band ranging from 100 Hz to 5000 Hz. The bass reflex resonance frequency was set to 40 Hz. As to the internal size of loudspeaker housing 31, the width in the X-axis direction was set to about 9 cm, the depth in the Y-axis direction was set to about 9 cm, and the height in the Z-axis direction was set to about 10 cm.

Compared with practical example 1, the loudspeaker device of comparative example 1 does not include acoustic port 35 and acoustic tube 36, but the loudspeaker housing had the sealed structure. The loudspeaker housing had the inner volume of 800 cubic centimeters. Other configurations of comparative example 1 are similar to those of practical example 1.

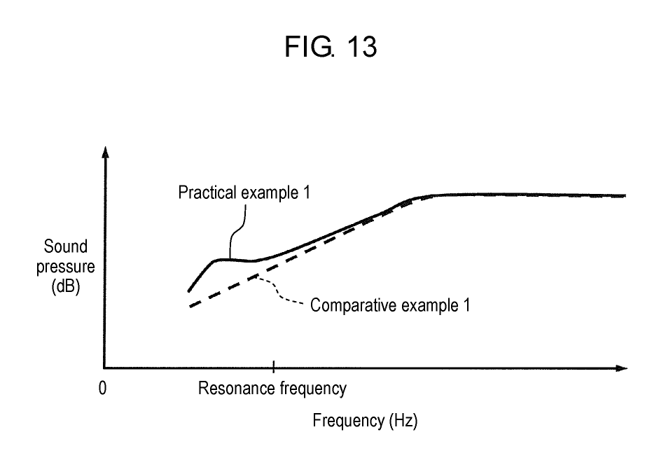

FIG. 13 schematically illustrates an example of a relationship between a sound pressure and a frequency of woofer 60 included in loudspeaker device 1 of the first exemplary embodiment. FIG. 13 is a graph illustrating a relationship between the sound pressure and the frequency of the woofer including two woofer loudspeaker units with respect to practical example 1 indicated by a solid line and comparative example 1 indicated by a broken line. In FIG. 13, a vertical axis indicates the sound pressure (unit: dB) and a horizontal axis indicates the frequency (unit: Hz).

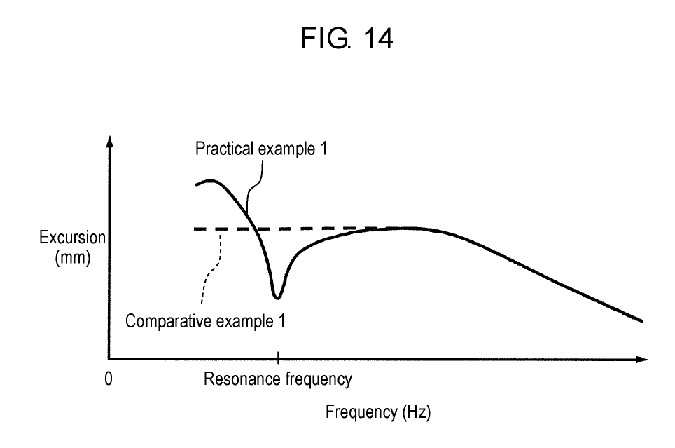

FIG. 14 schematically illustrates an example of a relationship between an excursion and a frequency of a diaphragm of a woofer loudspeaker unit included in loudspeaker device 1 of the first exemplary embodiment. FIG. 14 is a graph illustrating a relationship between the excursion and the frequency of the diaphragm of the woofer loudspeaker unit of the woofer with respect to practical example 1 indicated by the solid line and comparative example 1 indicated by the broken line. In FIG. 14, a vertical axis indicates the excursion (unit: mm) and a horizontal axis indicates the frequency (unit: Hz).

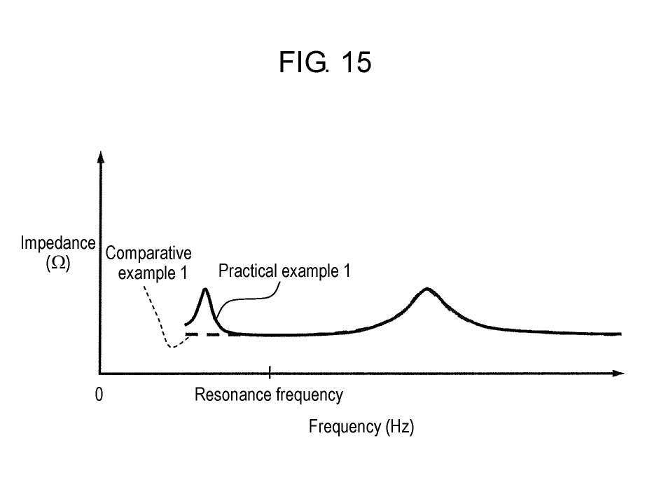

FIG. 15 schematically illustrates an example of a relationship between impedance and a frequency of the woofer loudspeaker unit included in loudspeaker device 1 of the first exemplary embodiment. FIG. 15 is a graph illustrating a relationship between the impedance and the frequency of the woofer loudspeaker unit of the woofer with respect to practical example 1 indicated by the solid line and comparative example 1 indicated by the broken line. In FIG. 15, a vertical axis indicates the impedance (unit: C2) and a horizontal axis indicates the frequency (unit: Hz).

As illustrated in FIG. 13, compared with comparative example 1, the sound pressure of woofer 60 (low-pitched sound region) in practical example 1 is increased by the influence of the bass reflex resonance in the frequency band near 40 Hz that is the bass reflex resonance frequency.

On the other hand, as illustrated in FIG. 14, compared with comparative example 1, the excursion of the diaphragm of the woofer loudspeaker unit in practical example 1 is largely decreased in the frequency band near 40 Hz that is the bass reflex resonance frequency. Thus, in practical example 1, the excursion of the diaphragm is suppressed in the deep low-pitched sound region near 40 Hz, so that the sound quality and sound reliability can be assured.

As illustrated in FIG. 15, the impedance of the woofer loudspeaker unit in practical example 1 is influenced by a diaphragm speed of the bass reflex resonance, and two peaks are generated in the low frequency band. The impedance of comparative example 1 has only one peak because the loudspeaker housing has the sealed structure and one resonance system. In practical example 1, the bass reflex resonance frequency exists between the two peaks. With decreasing impedance near the bass reflex resonance frequency, the excursion of the diaphragm can be efficiently suppressed to a lower level.

### [1-4. Effect and the Like]

As described above, in the first exemplary embodiment, a loudspeaker device includes a plurality of loudspeaker units and a plurality of horns. The plurality of horns are provided in the plurality of loudspeaker units, respectively, and each of the plurality of horns restricts spread of sound output from a corresponding one of the loudspeaker units to a predetermined range.

Loudspeaker device 1 is an example of the loudspeaker device. The plurality of tweeter units 12 (first tweeter unit 121, second tweeter unit 122, and third tweeter unit 123) are an example of the plurality of loudspeaker units. The plurality of directional control horns 13 (first directional control horn 131, second directional control horn 132, and third directional control horn 133) are an example of the plurality of horns.

For example, in the example shown in the first exemplary embodiment, loudspeaker device 1 includes the plurality of tweeter units 12 (first tweeter unit 121, second tweeter unit 122, and third tweeter unit 123) and the plurality of directional control horns 13 (first directional control horn 131, second directional control horn 132, and third directional control horn 133), which are provided in first tweeter unit 121, second tweeter unit 122, and third tweeter unit 123, respectively, to restrict the spread of the sound output from the corresponding one of first tweeter unit 121, second tweeter unit 122, and third tweeter unit 123 to the predetermined range.

In loudspeaker device 1 having the above configuration, the sounds output from plurality of tweeter units 12 (first tweeter unit 121, second tweeter unit 122, and third tweeter unit 123) are diffused with the plurality of directional control horns 13 (first directional control horn 131, second directional control horn 132, and third directional control horn 133) in the plurality of predetermined ranges. On the other hand, the directional ranges of the sounds output from first tweeter unit 121, second tweeter unit 122, and third tweeter unit 123 are restricted by first directional control horn 131, second directional control horn 132, and third directional control horn 133, whereby the sounds are emitted while the sound pressures are kept constant over the wide range. Thus, the sounds emitted from the plurality of directional control horns 13 (first directional control horn 131, second directional control horn 132, and third directional control horn 133) are widely diffused. This enables a user to listen to the sounds reproduced with first tweeter unit 121, second tweeter unit 122, and third tweeter unit 123 with a little change in sound quality at a listening position in the relatively wide range.

In the loudspeaker device, the plurality of loudspeaker units may include a first loudspeaker unit, a second loudspeaker unit disposed in a direction orthogonal to the first loudspeaker unit, and a third loudspeaker unit disposed in the direction orthogonal to the first loudspeaker unit and in an opposite direction to the second loudspeaker unit.

First tweeter unit 121 is an example of the first loudspeaker unit. Second tweeter unit 122 is an example of the second loudspeaker unit. Third tweeter unit 123 is an example of the third loudspeaker unit.

For example, in the example shown in the first exemplary embodiment, loudspeaker device 1 includes first tweeter unit 121, second tweeter unit 122 disposed in a direction orthogonal to first tweeter unit 121, and third tweeter unit 123 disposed in the direction orthogonal to first tweeter unit 121 and in an opposite direction to second tweeter unit 122.

In loudspeaker device 1, first tweeter unit 121 is disposed while oriented toward front face 1a of loudspeaker device 1, second tweeter unit 122 is disposed while oriented toward side face 1b of loudspeaker device 1, and third tweeter unit 123 is disposed while oriented toward side face 1c of loudspeaker device 1. Therefore, the sounds output from first tweeter unit 121, second tweeter unit 122, and third tweeter unit 123 are diffused in the wide range of the front and side of loudspeaker device 1. Accordingly, the user can clearly listen to the sounds output from first tweeter unit 121, second tweeter unit 122, and third tweeter unit 123 at various positions around loudspeaker device 1.

In the loudspeaker device, the plurality of horns may include a first horn provided in the first loudspeaker unit, a second horn provided in the second loudspeaker unit, and a third horn provided in the third loudspeaker unit. The first horn, the second horn, and the third horn may be configured to restrict the spread of the sound, and configured such that the ranges, where the spread of the sound is restricted, become substantially equal to one another.

First directional control horn 131 is an example of the first horn. Second directional control horn 132 is an example of the second horn. Third directional control horn 133 is an example of the third horn.

For example, in the example shown in the first exemplary embodiment, loudspeaker device 1 includes first directional control horn 131 provided in first tweeter unit 121, second directional control horn 132 provided in second tweeter unit 122, and third directional control horn 133 provided in third tweeter unit 123. First directional control horn 131, second directional control horn 132, and third directional control horn 133 are configured to restrict the spread of the sound, and configured such that the ranges, where the spread of the sound is restricted, become substantially equal to one another.

In loudspeaker device 1 having the above configuration, it is possible to equalize the sounds diffused with first directional control horn 131, second directional control horn 132, and third directional control horn 133. Sound unevenness caused by a listening position can be reduced with respect to the sounds output from first tweeter unit 121, second tweeter unit 122, and third tweeter unit 123.

In the loudspeaker device, the first horn may include a first opening at a distal end from the first loudspeaker unit. The second horn may include a second opening at a distal end from the second loudspeaker unit. The third horn may include a third opening at a distal end from the third loudspeaker unit. Each of the first opening, the second opening, and the third opening may be disposed along each of three surfaces of four surfaces constituting a square cylinder in the loudspeaker device.

Opening 13f of first directional control horn 131 is an example of the first opening. Opening 13f of second directional control horn 132 is an example of the second opening. Opening 13f of third directional control horn 133 is an example of the third opening. Side faces 1a, 1b, and 1c are an example of the three surfaces of the four surfaces constituting the square cylinder in the loudspeaker device.

For example, in the example shown in the first exemplary embodiment, in loudspeaker device 1, first directional control horn 131 includes opening 13f at a distal end from first tweeter unit 121. Second directional control horn 132 includes opening 13f at a distal end from second tweeter unit 122. Third directional control horn 133 includes opening 13f at a distal end from third tweeter unit 123. Each of openings 13f of first directional control horn 131, second directional control horn 132, and third directional control horn 133 is disposed along each of the three surfaces (side faces 1a, 1b, and 1c) of the four surfaces (side faces 1a, 1b, 1c, and 1d) constituting the square cylinder in loudspeaker device 1.

In loudspeaker device 1 having the above configuration, first directional control horn 131, second directional control horn 132, and third directional control horn 133 can be disposed such that openings 13f of first directional control horn 131, second directional control horn 132, and third directional control horn 133 do not overlap one another. Therefore, in loudspeaker device 1, diffusion ranges of the sounds emitted from first directional control horn 131, second directional control horn 132, and third directional control horn 133 are widened, and the interference among the sounds is reduced.

In the loudspeaker device, the plurality of horns may be arrayed. Each of the plurality of horns may include a first wall extending along an array direction of the plurality of horns and a second wall disposed at a position facing the first wall. The second wall may be inclined with respect to the first wall such that the sound output from the loudspeaker unit is spread in a direction from the first wall toward the second wall.

Bottom wall 13d is an example of the first wall. Upper wall 13c is an example of the second wall.

For example, in the example shown in the first exemplary embodiment, in loudspeaker device 1, first directional control horn 131, second directional control horn 132, and third directional control horn 133 are arrayed. Each of first directional control horn 131, second directional control horn 132, and third directional control horn 133 includes: bottom wall 13d extending along the array direction of first directional control horn 131, second directional control horn 132, or third directional control horn 133; and upper wall 13c disposed at the position facing bottom wall 13d. Each upper wall 13c is inclined with respect to bottom wall 13d such that the sound output from first tweeter unit 121, second tweeter unit 122, or third tweeter unit 123 is spread in the direction from bottom wall 13d toward upper wall 13c.

In the case that loudspeaker device 1 having the above configuration is mounted on the mounting surface substantially parallel to the horizontal plane, the sounds output from first tweeter unit 121, second tweeter unit 122, and third tweeter unit 123 are diffused obliquely upward. Accordingly, even if loudspeaker device 1 is mounted on the mounting surface located at a relatively low position, loudspeaker device 1 can sufficiently diffuse the sounds output from first tweeter unit 121, second tweeter unit 122, and third tweeter unit 123 in the obliquely upward space.

The loudspeaker device may further include the low-pitched loudspeaker unit in addition to the plurality of high-pitched loudspeaker units as the plurality of loudspeaker units. The plurality of high-pitched loudspeaker units and the plurality of horns provided in the plurality of high-pitched loudspeaker units may be disposed above the low-pitched loudspeaker unit.

First tweeter unit 121, second tweeter unit 122, and third tweeter unit 123 are an example of the plurality of high-pitched loudspeaker units. Each of upper woofer loudspeaker unit 32 and lower woofer loudspeaker unit 33 is an example of the low-pitched loudspeaker unit.

For example, in the example shown in the first exemplary embodiment, loudspeaker device 1 includes first tweeter unit 121, second tweeter unit 122, and third tweeter unit 123, which are an example of the high-pitched loudspeaker units, and upper woofer loudspeaker unit 32 and lower woofer loudspeaker unit 33, which are an example of the low-pitched loudspeaker unit. First tweeter unit 121, second tweeter unit 122, third tweeter unit 123, first directional control horn 131, second directional control horn 132, and third directional control horn 133 are disposed above upper woofer loudspeaker unit 32 and lower woofer loudspeaker unit 33 in loudspeaker device 1.

In loudspeaker device 1 having the above configuration, high-pitched first tweeter unit 121, second tweeter unit 122, and third tweeter unit 123 differ in the disposition position from low-pitched upper woofer loudspeaker unit 32 and lower woofer loudspeaker unit 33, so that mixing of the sounds is suppressed.

The loudspeaker device may further include a low-pitched loudspeaker housing in which the low-pitched loudspeaker unit is provided and an acoustic tube. The acoustic tube communicates an inside and an outside of the low-pitched loudspeaker housing to each other, has a predetermined length, and is accommodated in the low-pitched loudspeaker housing while spirally bent.

Loudspeaker housing 31 is an example of the low-pitched loudspeaker housing. Acoustic tube 36 is an example of the acoustic tube.

For example, in the example shown in the first exemplary embodiment, loudspeaker device 1 includes loudspeaker housing 31 in which upper woofer loudspeaker unit 32 and lower woofer loudspeaker unit 33 are provided and acoustic tube 36 communicating the inside and outside of loudspeaker housing 31 to each other. Acoustic tube 36 has a predetermined length, and is accommodated in loudspeaker housing 31 while spirally bent. Upper woofer loudspeaker unit 32 and lower woofer loudspeaker unit 33 may be mounted on loudspeaker housing 31 so as to face the inside and outside of loudspeaker housing 31.

In loudspeaker device 1 having the above configuration, when upper woofer loudspeaker unit 32 and lower woofer loudspeaker unit 33 vibrate, gas in loudspeaker housing 31 (that is, the gas in internal space 34) resonates at a specific frequency. In loudspeaker device 1, the sound pressure can be increased near the resonance frequency by the resonance of the gas in loudspeaker housing 31. The resonance frequency of the gas in loudspeaker housing 31 varies depending on the length of acoustic tube 36. In loudspeaker device 1, acoustic tube 36 is accommodated in loudspeaker housing 31 while spirally bent, so that acoustic tube 36 can be lengthened compared with the case that the acoustic tube is not spirally bent. Accordingly, in loudspeaker device 1, relatively long acoustic tube 36 can be accommodated in loudspeaker housing 31 even if necessity to form acoustic tube 36 relatively long arises in order to set the resonance frequency to a target frequency. Therefore, the excursions of diaphragm 32a of upper woofer loudspeaker unit 32 and diaphragm 33a of lower woofer loudspeaker unit 33 can be decreased in the deep low-pitched sound region. Further, when acoustic tube 36 is spirally formed, acoustic tube 36 can largely and uniformly bent. Therefore, the noise generated in the bent portion of acoustic tube 36 can be suppressed.

The loudspeaker device may further include a diffuser body. The diffuser body is provided at a position facing the low-pitched loudspeaker unit on the outside of the low-pitched loudspeaker housing, and diffuses the sound output from the low-pitched loudspeaker unit. The low-pitched loudspeaker unit may be provided while oriented toward a direction different from any direction of the plurality of high-pitched loudspeaker units.

Each of diffuser body 22 and diffuser body 42 is an example of the diffuser body.

For example, in the example shown in the first exemplary embodiment, loudspeaker device 1 includes diffuser body 22, which is provided at the position facing upper woofer loudspeaker unit 32 on the outside of loudspeaker housing 31 and diffuses the sound output from upper woofer loudspeaker unit 32 in a predetermined direction. Loudspeaker device 1 also includes diffuser body 42, which is provided at the position facing lower woofer loudspeaker unit 33 on the outside of loudspeaker housing 31 and diffuses the sound output from lower woofer loudspeaker unit 33 in a predetermined direction. Upper woofer loudspeaker unit 32 and lower woofer loudspeaker unit 33 are disposed in the directions different from any direction of first tweeter unit 121, second tweeter unit 122, and third tweeter unit 123.

In loudspeaker device 1 having the above configuration, the sound reproduced with upper woofer loudspeaker unit 32 can widely be diffused, and the sound reproduced with lower woofer loudspeaker unit 33 can widely be diffused. Accordingly, loudspeaker device 1 can spread the directional ranges of the sounds reproduced with upper woofer loudspeaker unit 32 and lower woofer loudspeaker unit 33. Diffuser body 22 or diffuser body 42 may diffuse the sound emitted from upper woofer loudspeaker unit 32 or lower woofer loudspeaker unit 33 while changing the direction of the sound by way that the sound collides with diffuser body 22 or diffuser body 42. In loudspeaker device 1, each of upper woofer loudspeaker unit 32 and lower woofer loudspeaker unit 33 is disposed in the directions different from any direction of first tweeter unit 121, second tweeter unit 122, and third tweeter unit 123. Therefore, loudspeaker device 1 can be miniaturized because a freedom degree is generated in the disposition of the loudspeaker unit.

In loudspeaker device 1 of the first exemplary embodiment, the predetermined length of acoustic tube 36 is set such that the frequencies of upper woofer loudspeaker unit 32 and lower woofer loudspeaker unit 33 are set lower than a predetermined frequency when a gas speed (gas speed in tube) in acoustic tube 36 is maximized by the resonance of the gas in loudspeaker housing 31.

In loudspeaker device 1, the noise is easily generated when the gas speed (gas speed in tube) in acoustic tube 36 is enhanced. The frequencies of upper woofer loudspeaker unit 32 and lower woofer loudspeaker unit 33 is set lower than the predetermined frequency (for example, the frequencies are lowered to a low-pitched sound frequency band hardly including the sounds reproducible with upper woofer loudspeaker unit 32 and lower woofer loudspeaker unit 33) when the noise is maximized (that is, the gas speed (gas speed in tube) in acoustic tube 36 is maximized), which allows the large reduction of the noise audible by the user. At this point, for example, the predetermined frequency may be a frequency of the low-pitched sound lower than or equal to the lowest-pitched sounds reproducible with upper woofer loudspeaker unit 32 and lower woofer loudspeaker unit 33.

Loudspeaker device 1 of the first exemplary embodiment includes the two woofer loudspeaker units (upper woofer loudspeaker unit 32 and lower woofer loudspeaker unit 33). In loudspeaker device 1, when the plurality of woofer loudspeaker units (upper woofer loudspeaker unit 32 and lower woofer loudspeaker unit 33) are provided, the sound can be reproduced with the high sound pressure even if the plurality of woofer loudspeaker units are small.

In loudspeaker device 1 of the first exemplary embodiment, acoustic tube 36 is disposed between upper woofer loudspeaker unit 32 and lower woofer loudspeaker unit 33, which are disposed opposite to each other (that is, disposed in the directions opposite to each other) in loudspeaker housing 31. In loudspeaker device 1 having the above configuration, acoustic tube 36 can suppress the interference between the vibration waves generated with diaphragm 32a of upper woofer loudspeaker unit 32 and diaphragm 33a of lower woofer loudspeaker unit 33, which are disposed opposite to each other, and acoustic tube 36 can suppress the generation of the standing wave caused by the interference between the vibration waves. Accordingly, the influence of the standing wave on the resonance of the gas in loudspeaker housing 31 can be suppressed in loudspeaker device 1.

Loudspeaker device 1 of the first exemplary embodiment includes circuit board 52 on which the circuit is mounted, the circuit performing the boost control on upper woofer loudspeaker unit 32 and lower woofer loudspeaker unit 33 in order to increase the sound pressures of upper woofer loudspeaker unit 32 and lower woofer loudspeaker unit 33 when the frequencies of upper woofer loudspeaker unit 32 and lower woofer loudspeaker unit 33 exist at the resonance frequency of the gas in loudspeaker housing 31 or in the frequency band near resonance frequency. In loudspeaker device 1, the excursions of diaphragm 32a of upper woofer loudspeaker unit 32 and diaphragm 33a of lower woofer loudspeaker unit 33 are decreased when the frequencies of upper woofer loudspeaker unit 32 and lower woofer loudspeaker unit 33 exist at the resonance frequency or in the frequency band near resonance frequency. However, in loudspeaker device 1, the sound pressure in the frequency band, in which the excursions of diaphragm 32a and 33a are decreased, is increased by the boost control, so that the sound quality can be assured after the sound-pressure increase performed by the boost control.

In loudspeaker device 1 of the first exemplary embodiment, first directional control horn 131, second directional control horn 132, and third directional control horn 133 are disposed adjacent to one another such that the directional ranges of first directional control horn 131, second directional control horn 132, and third directional control horn 133 do not substantially overlap one another. The interference among the sounds emitted from first directional control horn 131, second directional control horn 132, and third directional control horn 133 is suppressed in loudspeaker device 1 having the above configuration. Accordingly, while the sound pressures of the sounds emitted from first directional control horn 131, second directional control horn 132, and third directional control horn 133 are kept constant, disturbances of the sounds are suppressed and widely diffused. This enables the user to listen to the sounds reproduced with first tweeter unit 121, second tweeter unit 122, and third tweeter unit 123 with a little change in sound quality at a listening position in the relatively wide range.

In loudspeaker device 1 of the first exemplary embodiment, first directional control horn 131, second directional control horn 132, and third directional control horn 133 are disposed such that the directional ranges of first directional control horn 131, second directional control horn 132, and third directional control horn 133 are adjacent to one another in the substantially horizontal direction. In loudspeaker device 1 having the above configuration, the sounds can widely be diffused in the horizontal direction with first directional control horn 131, second directional control horn 132, and third directional control horn 133. Accordingly, in loudspeaker device 1, the directional characteristics, in horizontal direction, of the sounds reproduced with first tweeter unit 121, second tweeter unit 122, and third tweeter unit 123 can be reduced.

Loudspeaker device 1 of the first exemplary embodiment includes tweeter 10 and woofer 60 while tweeter 10 and woofer 60 are integrated. In loudspeaker device 1, each of upper woofer loudspeaker unit 32 and lower woofer loudspeaker unit 33 of loudspeaker housing 31 is configured to improve the sound quality in the deep low-pitched sound region, and each of first tweeter unit 121 including first directional control horn 131, second tweeter unit 122 including second directional control horn 132, and third tweeter unit 123 including third directional control horn 133 is configured to improve the sound quality in the high-pitched sound region, which allows the sound quality of the reproduced sound to be improved from the deep low-pitched sound region to the high-pitched sound region.

### Other Exemplary Embodiments

The first exemplary embodiment has been described above as an illustration of the technology of the present disclosure. However, the technology of the present disclosure is not limited to the first exemplary embodiment, and can also be applied to embodiments in which various changes, replacements, additions, and omissions can be made. Furthermore, a new exemplary embodiment can also be made by a combination of the first exemplary embodiment and each component described in the following exemplary embodiments.

Other exemplary embodiments will be described below.

The first exemplary embodiment has described a configuration example in which, in loudspeaker device 1, woofer loudspeaker 30 includes the two woofer loudspeaker units, namely, upper woofer loudspeaker unit 32 and lower woofer loudspeaker unit 33. However, the present disclosure is not limited to the configuration example of the first exemplary embodiment. Alternatively, woofer loudspeaker 30 may include one or at least three woofer loudspeaker units.

The first exemplary embodiment has described a configuration example in which, in loudspeaker device 1, acoustic tube 36 included in woofer loudspeaker 30 is formed into a smoothly curved spiral shape having the circular section. However, the present disclosure is not limited to the configuration example of the first exemplary embodiment. Alternatively, acoustic tube 36 may have a predetermined length of the tube and a predetermined sectional area of the tube. The sectional shape of acoustic tube 36 is not limited to the circular shape, but may be a polygonal shape such as a rectangle, or an ellipse or an oval. The shape of acoustic tube 36 is not limited to the spiral shape, but may be any shape as long as acoustic tube 36 can be accommodated in internal space 34. In the case that acoustic tube 36 has the bent shape, for example, acoustic tube 36 may have a spiral shape, a shape in which the tube reciprocates in the Z-axis direction in internal space 34, a shape in which the tube reciprocates in the X-axis or Y-axis direction, or a combination thereof.

The first exemplary embodiment has described a configuration example in which, in loudspeaker device 1, whole acoustic tube 36 of woofer loudspeaker 30 is included in internal space 34 of loudspeaker housing 31. However, the present disclosure is not limited to the configuration example of the first exemplary embodiment. Alternatively, acoustic tube 36 may extend partially to the outside of loudspeaker housing 31.

The first exemplary embodiment has described a configuration example in which, in loudspeaker device 1, tweeter 10 includes the three sets of tweeter unit 12 and directional control horn 13. However, the present disclosure is not limited to the configuration example of the first exemplary embodiment. Alternatively, tweeter 10 may include two or four sets of tweeter unit 12 and directional control horn 13. For example, in the configuration example in which tweeter 10 includes the four sets of tweeter unit 12 and directional control horn 13, tweeter 10 can substantially nondirectionally reproduce the sound over 360 degrees in the horizontal direction around loudspeaker device 1. In the configuration example in which tweeter 10 includes the two sets of tweeter unit 12 and directional control horn 13, the nondirectional sound can widely be reproduced by the change in directional angle of directional control horn 13.

The first exemplary embodiment has described a configuration example in which, in loudspeaker device 1, tweeter 10 includes the three directional control horns 13 having the directional angle of 90 degrees. However, the present disclosure is not limited to the configuration example of the first exemplary embodiment. Directional control horn 13 may have the directional angle except for 90 degrees. The first exemplary embodiment has described a configuration example in which tweeter units 12 are disposed while oriented at right angles to each other, otherwise directional control horn 13 may have the directional angle except for 90 degrees. The plurality of directional control horns 13 may differ from each other in the directional angle.

The first exemplary embodiment has described a configuration example in which, in tweeter 10, three directional control horns 13 are disposed such that central axis 13gc of each directional control horn 13 is set along the XY-plane. However, the present disclosure is not limited to the configuration example of the first exemplary embodiment. In tweeter 10, central axis 13gc of directional control horn 13 may be set along any plane.

The first exemplary embodiment has described a configuration example in which, in loudspeaker device 1, tweeter 10 is disposed on woofer 60. However, the present disclosure is not limited to the configuration example of the first exemplary embodiment. The disposition form and disposition order of woofer 60 and tweeter 10 may be set anyway.

The first exemplary embodiment has described a configuration example in which, in woofer 60 of loudspeaker device 1, upper woofer loudspeaker unit 32 and lower woofer loudspeaker unit 33 are vertically disposed. However, the present disclosure is not limited to the configuration example of the first exemplary embodiment. Woofer 60 may be disposed in any direction.

The first exemplary embodiment has described a configuration example in which loudspeaker device 1 includes tweeter 10 and woofer 60 while tweeter 10 and woofer 60 are integrated. However, the present disclosure is not limited to the configuration example of the first exemplary embodiment. Loudspeaker device 1 may be configured to include only one of tweeter 10 and woofer 60.

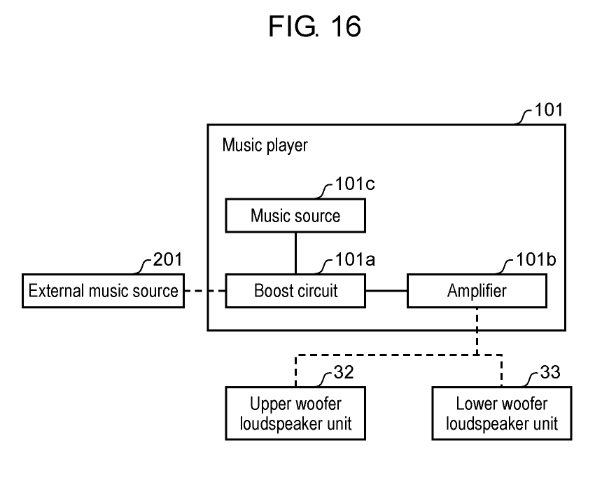

The first exemplary embodiment has described a configuration example in which, in loudspeaker device 1, the circuit mounted on circuit board 52 (see FIG. 10) performs the control (boost control) in which upper woofer loudspeaker unit 32 and lower woofer loudspeaker unit 33 are boosted to increase the sound pressure. However, the present disclosure is not limited to the configuration example of the first exemplary embodiment. An external device of loudspeaker device 1 may perform the boost control on upper woofer loudspeaker unit 32 and lower woofer loudspeaker unit 33. For example, music player 101 may perform the boost control on upper woofer loudspeaker unit 32 and lower woofer loudspeaker unit 33. FIG. 16 illustrates a configuration example in this case.

FIG. 16 is a block diagram illustrating the configuration example of components associated with the boost control of the woofer loudspeaker unit included in loudspeaker device 1 of the first exemplary embodiment. In the case that music player 101 performs the boost control on upper woofer loudspeaker unit 32 and lower woofer loudspeaker unit 33, music player 101 includes boost circuit 101a that performs the boost control and amplifier 101b as illustrated in the block diagram in FIG. 16. Boost circuit 101a boosts a signal received from music source 101c, such as a CD player or the radio, which is included in music player 101 or external music source 201, such as an external device, with which music player 101 communicates. Amplifier 101b amplifies the boosted signal, and transmits the signal to upper woofer loudspeaker unit 32 and lower woofer loudspeaker unit 33 of loudspeaker device 1. Acoustic system 100 including loudspeaker device 1 may be configured in this manner. At this point, the circuit mounted on circuit board 52 may not have the function of controlling upper woofer loudspeaker unit 32 and lower woofer loudspeaker unit 33. Circuit board 52 may be configured to act only as a relay board relaying electrical connection of a signal line (lead) connected from music player 101 to loudspeaker device 1 and upper woofer loudspeaker unit 32 and lower woofer loudspeaker unit 33. Circuit board 52 may relay the electrical connection of the lead connected from music player 101 to loudspeaker device 1 and tweeter unit 12.

The first exemplary embodiment has described a configuration example in which, in loudspeaker device 1, the circuit mounted on tweeter circuit board 14 (see FIG. 12) of tweeter 10 controls tweeter unit 12. However, the present disclosure is not limited to the configuration example of the first exemplary embodiment. Alternatively, an external device of loudspeaker device 1 may control tweeter unit 12. For example, music player 101 may control tweeter unit 12. At this point, tweeter circuit board 14 may be configured to act only as a relay board relaying electrical connection of the lead connected from music player 101 to loudspeaker device 1 or the lead extending from music player 101 through circuit board 52 of pedestal housing 51 and tweeter unit 12.

In the first exemplary embodiment, the term “the frequency of the loudspeaker unit” is used. This means “the frequency of the sound currently reproduced with the loudspeaker unit” or “the frequency of the sound reproduced with the loudspeaker unit”.

The above exemplary embodiments are described as an illustration of the technology of the present disclosure. The accompanying drawings and the detailed description are made for this end.

Accordingly the components illustrated or described in the accompanying drawings and detailed description includes not only the components necessary for solving the problem but also the components unnecessary for solving the problem in order to illustrate the technique. It is noted that the unnecessary components are not immediately recognized as the necessary components even if the unnecessary components are illustrated or described in the accompanying drawings or detailed description.

The above exemplary embodiments are intended to illustrate the technology in the present disclosure, and various changes, replacements, additions, omissions, and the like may be made within the scope of the claims or equivalents thereof.

### INDUSTRIAL APPLICABILITY

The present disclosure can be applied to a loudspeaker device and an instrument including the loudspeaker device. Specifically, the present disclosure can be applied to various instruments, which include the loudspeaker devices, such as an acoustic system including a music player, an audio and video system including a monitor such as a television, and a personal computer.

### REFERENCE MARKS IN THE DRAWINGS

1 loudspeaker device
1a side face (front face)
1b, 1c side face
1d side face (rear face)
1e top face
1f bottom face
2 exterior net
3 top board
10 tweeter
11 tweeter frame
11a upper edge
11b support
11c rear face wall
12 tweeter unit
13 directional control horn
13a, 13b sidewall
13aa, 13ba bent portion
13c upper wall
13d bottom wall
13e, 13f opening
14 tweeter circuit board
20 upper diffuser
21 upper frame
21a support
21b support plate
22, 42 diffuser body
22a, 42a diffusion part
30 woofer loudspeaker
31 loudspeaker housing
31a, 31b, 31c, 31d sidewall
31e upper wall
31f lower wall
32 upper woofer loudspeaker unit
32a, 33a diaphragm
33 lower woofer loudspeaker unit
34 internal space
35 acoustic port
35a port plate
36 acoustic tube
36a flange
36b end
37 sound absorbing material
40 lower diffuser
41 lower frame
41a support
41b beam
50 pedestal
51 pedestal housing
52 circuit board
60 woofer
100 acoustic system
101 music player
101a boost circuit
110 operating part
101b amplifier
101c music source
121 first tweeter unit
122 second tweeter unit
123 third tweeter unit
131 first directional control horn
132 second directional control horn
133 third directional control horn
201 external music source
A directional range
C diffusion reference point
L1, L2 line segment

1. A loudspeaker device comprising:
a plurality of loudspeaker units; and
a plurality of horns provided in the plurality of loudspeaker units, respectively, the plurality of horns each restricting spread of sound output from a corresponding one of the loudspeaker units to a predetermined range.

2. The loudspeaker device according to claim 1, wherein
the plurality of loudspeaker units include:
a first loudspeaker unit;
a second loudspeaker unit disposed in a direction orthogonal to the first loudspeaker unit; and
a third loudspeaker unit disposed in the direction orthogonal to the first loudspeaker unit and in an opposite direction to the second loudspeaker unit.

3. The loudspeaker device according to claim 2, wherein
the plurality of horns include:
a first horn provided in the first loudspeaker unit;
a second horn provided in the second loudspeaker unit; and
a third horn provided in the third loudspeaker unit, and
the first horn, the second horn, and the third horn are configured to restrict the spread of the sound, and configured such that ranges in each of which the spread of the sound is restricted become substantially identical to one another.

4. The loudspeaker device according to claim 3, wherein
the first horn includes a first opening at a distal end from the first loudspeaker unit,
the second horn includes a second opening at a distal end from the second loudspeaker unit,
the third horn includes a third opening at a distal end from the third loudspeaker unit, and
each of the first opening, the second opening, and the third opening is disposed along each of three surfaces of four surfaces constituting a square cylinder in the loudspeaker device.

5. The loudspeaker device according to claim 1, wherein
the plurality of horns are arrayed,
each of the plurality of horns includes a first wall extending along an array direction of the plurality of horns and a second wall disposed at a position facing the first wall, and
the second wall is inclined with respect to the first wall such that the sound output from the loudspeaker unit is spread in a direction from the first wall toward the second wall.

6. The loudspeaker device according to claim 1, further comprising:
a plurality of high-pitched loudspeaker units as the plurality of loudspeaker units; and
a low-pitched loudspeaker unit,
wherein the plurality of high-pitched loudspeaker units and the plurality of horns provided in the plurality of high-pitched loudspeaker units are provided above the low-pitched loudspeaker unit.

7. The loudspeaker device according to claim 6, further comprising:
a low-pitched loudspeaker housing in which the low-pitched loudspeaker unit is provided; and
an acoustic tube communicating an inside and an outside of the low-pitched loudspeaker housing to each other, the acoustic tube having a predetermined length, the acoustic tube being accommodated in the low-pitched loudspeaker housing while spirally bent.

8. The loudspeaker device according to claim 7, further comprising a diffuser body diffusing the sound output from the low-pitched loudspeaker unit, the diffuser body being provided at a position facing the low-pitched loudspeaker unit on the outside of the low-pitched loudspeaker housing,
wherein the low-pitched loudspeaker unit is disposed in a direction different from any direction of the plurality of high-pitched loudspeaker units.
